(19) United States
(12) Patent Application Publication
(10) Pub. No.: US 2025/0346527 A1
(43) Pub. Date: Nov. 13, 2025

(54) GEOPOLYMER COATING FOR ACID AND ELEVATED TEMPERATURE RESISTANCE

(71) Applicant: W.R. Meadows, Hampshire, IL (US)

(72) Inventor: Kunal Kupwade-Patil, Hampshire, IL (US)

(21) Appl. No.: 19/189,559

(22) Filed: Apr. 25, 2025

Related U.S. Application Data
(60) Provisional application No. 63/644,367, filed on May 8, 2024.

(51) Int. Cl. C04B 12/00; C04B 7/153; C04B 7/24; C04B 14/06; C04B 16/06; C04B 20/00; C04B 22/06; C04B 28/00; C04B 28/02; C04B 28/08; C04B 40/00; C04B 40/02; C04B 103/00; C04B 103/22; C04B 103/32; C04B 103/56; C04B 111/00; C04B 111/23

(52) U.S. Cl. CPC C04B 12/005; C04B 7/1535; C04B 7/243; C04B 14/06; C04B 16/0625; C04B 20/008; C04B 22/062; C04B 28/006; C04B 28/021; C04B 28/082; C04B 40/0046; C04B 40/0263; C04B 2103/0094; C04B 2103/22; C04B 2103/32; C04B 2103/58; C04B 2111/00215; C04B 2111/0025; C04B 2111/00482; C04B 2111/23; C04B 2201/50

(57) ABSTRACT

Geopolymer compositions incorporating slag or other alumino-silicate and calcium containing binder components are described. The geopolymer compositions incorporate C-(N)-A-S-H/C-A-S-H gels providing improved adhesion strength and resistance to chemical attack. Methods of methods of making and using the geopolymers are further described, with the embodied geopolymers being compatible with multiple conventional application processes, including pouring, spraying, screeding, and troweling.

### BACKGROUND

### Field

Embodiments relate to geopolymer compositions comprising slag and in particular, ground granulated blast-furnace slag compositions and coatings incorporating C-(N)-A-S-H/C-A-S-H gels, along with methods of making and using the geopolymers. The embodied geopolymers are compatible with multiple conventional application processes, including pouring, spraying, screeding, and troweling and show chemical resistance and elevated temperature resistance.

### Technical Background

Portland cement concrete (PCC) is a composite material composed of aggregate bonded with Portland cement (PC) as a binder. PCC is one of the most prevalent materials in worldwide construction, with current global PCC consumption at approximately 1 ton/year per person. Increasing demand for PCC has led to an increase in PC production, with global production of PC at >3 billion tons and projected to reach 6 billion tons per year by 2065.

The challenge for the concrete industry is that the production of concrete is both energy intensive and has a huge impact on the environment. In particular, PC production releases significant greenhouse gas emissions. And while PC is a relatively small fraction of concrete, it is responsible for about 74% to 81% of the CO₂ amount emitted from typical concrete mixes and is estimated to be responsible for about 3% of total global greenhouse gas emissions. Manufacture of 1 tonne of cement releases approximately 1 tonne of CO₂ and is currently responsible for 8-9% of the global anthropogenic CO₂ emission. (Monteiro, Paulo J M, Sabbie A. Miller, and Arpad Horvath. “Towards sustainable concrete.” Nature materials 16.7 (2017): 698-699).

In addition to the environmental costs, PC production requires large amounts of energy. The total required energy is manufacturing and processing PC accounts for 50-60% of the production costs. The typical PC plant needs around 110-120 kWh of electrical energy to produce one ton of PC and consumes 3000-6500 MJ of thermal energy to produce one ton of Portland clinker. This energy mostly comes from fossil fuels as either the primary or secondary source.

While PCC is used extensively in construction particularly where compressive strength is needed, there are applications where its properties are inadequate. For example, PCC has durability problems when used in highly acidic or salty environments where the PCC breaks down and loses its adhesive properties. There is a continuing need for development of improved eco-friendly construction materials as an alternative for PC.

### BRIEF SUMMARY

In one aspect, the present technology provides a geopolymer coating composition comprising, in total weight percent, (a) 20-50 wt % of an alumino-silicate source comprising at least 20 wt % slag, based on the total weight of the alumino-silicate source; (b) 20-65 wt % aggregate; (c) >0-5 wt % superplasticizer; (d) 10-35 wt % of an alkali silicate component; (e) 3-15 wt % of an alkali hydroxide component; and (f) >0-10 wt % retarding admixture.

In a further aspect, the present technology provides a method of forming a geopolymer, the method comprising (a) forming a dry admixture of components comprising (i) an alumino-silicate source comprising at least 20 wt % slag, based on the total weight of the alumino-silicate source; (ii) aggregate; (iii) superplasticizer; and (iv) retarding admixture, wherein the alumino-silicate source is in an amount of 20-50 wt %, the aggregate is in an amount of 20-65 wt %, the superplasticizer is in an amount of >0-5 wt %, and the retarding admixture is in an amount of >0-10 wt %, based on total weight of the geopolymer; (b) mixing an alkali silicate component with the dry admixture to form a mixture, wherein the alkali silicate component is in an amount of 10-35 wt %, based on the total weight of the geopolymer; (c) mixing an alkali hydroxide component with the mixture formed from step (b) to initiate an alkali activation process and form an activated composition; and (d) curing the activated composition to form a geopolymer.

In another aspect, the present technology provides a geopolymer formed from a geopolymer composition that comprises, in total weight percent, (a) 20-50 wt % of an alumino-silicate source comprising at least 20 wt % slag, based on the total weight of the alumino-silicate source; (b) 20-65 wt % aggregate; (c) >0-5 wt % superplasticizer; (d) 10-35 wt % of an alkali silicate component; (e) 3-15 wt % of an alkali hydroxide component; and (f) >0-10 wt % retarding admixture. The geopolymer provides a combination of acid resistance, brine resistance, and elevated temperature resistance properties.

In some embodiments, the geopolymer composition comprises ground granulated blast-furnace slag as the alumino-silicate source.

### BRIEF DESCRIPTION OF THE DRAWINGS

FIG. 1 shows the setting time for two different embodied compositions as per ASTM C191, Standard Test Methods for Time of Setting of Hydraulic Cement by Vicat Needle, ASTM Int'l.

FIG. 2 shows embodied compositions with various levels of retarding agent (1 wt %, 2 wt %, 3 wt %, and 5 wt %) and resulting setting times as per ASTM C191, Standard Test Methods for Time of Setting of Hydraulic Cement by Vicat Needle, ASTM Int'l.

FIG. 3 is a diagram comparing the adhesion strength for embodied compositions (fly ash/slag/aluminum oxide, slag) to a fly ash geopolymer. Adhesion tests are performed as per ASTM D 7234, Standard Test Method for Pull-Off Adhesion Strength of Coatings on Concrete Using Portable Pull Off Adhesion Testers, ASTM Int'l.

FIG. 4 pictorially illustrates fly ash, fly ash/slag/aluminum oxide, and slag based geopolymer coatings, and a coating-free substrate control exposed to 0.622 pH sulfuric acid. After 4 days of exposure, the fly ash geopolymer was completely destroyed whereas the Fly Ash/Slag/Aluminum oxide coating was debonded after 30 days of 0.622 pH sulfuric acid exposure. No signs of deterioration are observed on the slag based geopolymer after 60 days of exposure.

FIG. 5A and FIG. 5B show X-ray diffraction data comparing fly ash and slag based geopolymer compositions before (5A) and after (5B) exposure to sulfuric acid. The spectra compare the effect of sulfuric acid exposure on crystalline and amorphous components of the geopolymeric gel.

FIG. 6 shows MAS Nuclear Magnetic Resonance (NMR) for ²⁷Al for base slag powder (A), slag-based geopolymer coating (B), and fly ash geopolymer coating (C), with and without sulfuric acid exposure.

FIG. 7 pictorially illustrates a number of geopolymer compositions exposed to a pH 5.68 brine solution (5 M NaCl and 4 M KCl) at 250° F. (121° C.) for up to 44 days. Embodied Mixes 18 and 20 survived the brine attack with no signs of delamination or surface degradation after 44 days. Comparative Mix 3 (fly ash only) showed significant delamination after 9 days.

### DETAILED DESCRIPTION

In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the invention. In addition, like or identical reference numerals may be used to identify common or similar elements. Moreover, unless otherwise defined, all technical and scientific terms used herein have the same meaning as commonly understood by one of ordinary skill in the art to which this invention belongs. In case of conflict, the present specification, including the definitions herein, will control.

Although other methods can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. M ore specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the invention be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value, and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In some embodiments, there are a number of possible alternatives that can be chosen. In such cases, the terminology “at least one of [A], [B] or [C]” or “one or more of [A], [B] or [C]” is used to mean “either [A], [B], [C] or any possible combination of [A], [B] and [C], such as [A] and [B] or [B] and [C] or [A] and [C] or [A], [B], and [C].” In cases where “[A] or [B]” is used, it should be interpreted as “either or both” and not as alternatives—e.g., “[A] or [B]” is equivalent to “[A] or [B] or the combination [A] and [B].” For sake of clarity, the disclosure may include “and combinations thereof” to further clarify that in cases where alternatives are listed, the list further comprises combinations thereof.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

For the purposes of describing the embodiments, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the claims may utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the compositions described herein, certain impurities or components that are not intentionally added, can be present in the final composition. Such materials may be present in the composition in trace or minor amounts that are detectable via modern analytical methods and are referred to herein as “trace materials” or “tramp materials.”

As used herein, a composition having 0 wt % of a compound is defined as meaning that the compound, molecule, or element was not purposefully added to the composition, but the composition may still comprise the compound, typically in trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

Unless otherwise specified, the concentrations of all constituents recited herein are expressed in terms of weight percent (wt %).

### Geopolymers

Geopolymers are a class of inorganic binders composed of alumino-silicate rich waste materials, such as blast furnace slag or fly ash (FA) that are dissolved in alkaline activators based on sodium, potassium, or carbonate hydroxides. The dissolving of SiO₂ and Al₂O₃ compounds create silica and alumina oligomers, which then are polycondensed to form a polymer binder having an amorphous to a partially crystalline structure. Three types of oligomers can be developed based on the Si and Al ratio, including the polysialate (—Si—O—Al—O—), polysialate-siloxo (Si—O—Al—O—Si—O), and polysialate-disiloxo (Si—O—Al—O—Si—O—Si—O). Geopolymers have emerged as possible alternatives to Portland cement (PC), as they can be produced with remarkably less CO₂ emissions while exhibiting comparable mechanical and durability properties.

Geopolymer has previously been used in niche applications including refractory materials exposed to elevated temperature, soil grouting for stability and reduced seepage problems, lightweight foam for sandwich insulating panels, underwater grouts for reduced washout loss, masonry mortars and masonry units, and construction material for road subgrade. The novel geopolymers described herein have improved physical properties and durability, allowing for an expanded use of geopolymers in construction and improved durability and acid, brine, and thermal resistance in constructed materials.

Described herein are novel geopolymers comprising compositions for use in alkali activated systems. Alkali activated systems comprise one or more alumino-silicate binder sources in combination with one or more alkaline activators. The activator solutions produce an environment with a high pH value (e.g. hydroxides, silicates, carbonates or sulfates). Without wanting to be bound by theory, it is proposed that under high pH values, the breaking of Si—O—Si and Al—O—Si bonds in the alumino-silicate source convert the bonds to a colloid phase, allowing the combined products to react to form a nanosized gel structure that may undergo reorganization prior to polymerization and hardening. In the compositions and coatings described herein, the gel structure is primarily (Ca,Na) Sodium-Aluminum-Silicate-Hydrate gels, abbreviated (C,N)-A-S-H gels, along with lesser or trace amounts of Sodium-Aluminum-Silicate-Hydrate (N-A-S-H) gels and/or Calcium-Aluminum-Silicate-Hydrate (C-A-S-H) gels.

In addition to the alumino-silicate source and the alkaline activators, the compositions and coatings described herein comprise aggregate, and admixtures that comprise one or more superplasticizers and a shrinkage reducing admixture, and may further include a retarding agent and/or mini- or microfibers. Without being bound by theory, it is believed that the combination of particular alumina-silicate source(s), alkali activators, aggregate, and admixtures in the geopolymer compositions and coatings of the present technology provide a surprising combination of acid resistance, brine resistance, and elevated temperature resistance properties.

### Alumino-Silicate Sources

The alumino-silicate binder source used in the geopolymer compositions and coatings of the present technology comprises slag either alone, or in combination with one or more other alumino-silicate binder sources. Such other alumino-silicate binder sources can include fly ash, silica fume, metakaolin, calcined clay, bauxite powder, bottom ash, volcanic ash, rice husk ash, and shale powder. When other alumino-silicate binder sources are used in combination with slag, the other alumino-silicate binder source or sources can comprise up to about 80 wt % of the total weight of the alumino-silicate binder, alternatively up to 70 wt %, up to 60 wt %, up to 50 wt %, up to 40 wt %, up to 30 wt %, up to 20 wt %, or up to 10 wt %, by weight of the alumino-silicate binder. In addition to alumina and silica, in some embodiments, the alumino-silicate sources further comprise calcium oxide.

### Slag

Slag is an industrial waste product resulting from smelting iron or other ores or metals. It comprises a mixture of mainly silicon dioxide, aluminum oxide, calcium oxide, and magnesium oxide, with lesser amounts of other metals, such as iron, sodium, potassium, and manganese oxides. The particular amounts of the constituents vary depending on the type of slag. Types of slag include blast furnace slag, electric arc furnace oxidizing slag, electric arc furnace reducing slag, ladle furnace slag, and phosphorus slag. Table 1 provides a general description of different types of slag.

TABLE 1

| Types of | SiO₂ | Al₂O₃ | Fe₂O₃ | CaO | MgO | SO₃ | K₂O | Na₂O | TiO₂ | P₂O₅ | MnO | Cl | |
|---|---|---|---|---|---|---|---|---|---|---|---|---|---|
| slags | (%) | (%) | (%) | (%) | (%) | (%) | (%) | (%) | (%) | (%) | (%) | (%) | LOI |
| Ground | 32-42 | 7-16 | 0.1-1.5 | 32-45 | 0.1-10 | 2.43 | 0.50 | 0.25 | 0.47 | 0.01 | 0.2-1 | 0.05 | 0.1-3 |
| Granulated | | | | | | | | | | | | | |
| Blast | | | | | | | | | | | | | |
| Furnace | | | | | | | | | | | | | |
| Slag | | | | | | | | | | | | | |
| (GGBFS) | | | | | | | | | | | | | |
| Electric arc | 9-20 | 2-9 | 20.3-32.56 | 23.9-60 | 2.9-15 | 0.1-0.6 | 0.53 | 0.09 | 0.4-0.8 | — | 1-8 | — | 0.5-5 |
| furnace | | | | | | | | | | | | | |
| oxidizing | | | | | | | | | | | | | |
| slag (EOS) | | | | | | | | | | | | | |
| Electric arc | 9-25 | 2-10 | 3-30 | 20-65 | 2-17 | 1.80 | 0.52 | 0.09 | 0.2-0.8 | — | 0.2-0.4 | — | 0.5-5 |
| furnace | | | | | | | | | | | | | |
| reducing | | | | | | | | | | | | | |
| slag (ERS) | | | | | | | | | | | | | |
| Ladle | 2-35 | 5-35 | 0.9-3.3 | 30-60 | 1-12.6 | 0-0.3 | — | — | 0.3-0.9 | 0-0.4 | 0.2-1.4 | — | 0.72-4.71 |
| Furnace | | | | | | | | | | | | | |
| Slag | | | | | | | | | | | | | |
| Phosphorus | 2-40 | 5-35 | 0.1-3 | 30-50 | 1-10 | 5.28 | 0.9 | 1.51 | 0.23 | 2-6 | — | — | 0.1-3 |
| Slag | | | | | | | | | | | | | |

In the geopolymer compositions of the present technology, slag comprises at least 20 wt % of the alumino-silicate source, alternatively, at least 30 wt %, at least 40 wt %, at least 50 wt %, at least 60 wt %, at least 70 wt %, at least 80 wt %, at least 90 wt %, and preferably 100 wt % of the alumino-silicate source. In some embodiments, vitreous blast furnace slag that has been ground into powder (ground granulated blast furnace slag, “GGBFS”) is used as the alumino-silicate source. In general, GGBFS can comprise about 30 wt % to about 60 wt % silicon dioxide, about 5 wt % to about 25 wt % aluminum oxide, about 5 wt % to about 50 wt % calcium oxide, 0% to about 15 wt % magnesium oxide, and 0% to about 8 wt % weight iron oxide, it being understood that the percentages total 100%.

Particle sizes of the slag depend on the burning and grinding process of the slag. GGBFS can have a characteristic particle size, De, of from 2 μm to 50 μm. Electric arc furnace oxidizing slag and electric arc furnace reducing slag have mean particle sizes of about 2 μm to 7 mm, but particles larger than 5 mm need to be ground to a finer particle size. Ladle furnace slag typically has a mean particle size of 3 μm to 50 μm, and phosphorus slag typically has a mean particle size of 2 μm to 70 μm. Characteristic particle size is measured by suspending slag in isopropyl alcohol using the Laser Light Scattering technique with a particle size analyzer.

GGBFS typically has a loss on ignition of less than 3 wt %. In the cement industry, loss on ignition is used to determine the water content and/or carbonation in the cement as these reduce the quality, and is calculated by comparing the weight of a sample before and after it has been subjected to high temperatures (950° C.) during ignition.

### Fly Ash

Fly ash is a by-product of coal burning in thermal power plants. Fly ash is the fine particulate residue removed from the gas stream by a dust-collection system before the gas stream is released into the atmosphere. The particles are typically spherical, and range in size from less than 1 μm to about 150 μm. The chemical composition of fly ash is determined by the chemical composition of the burning coal and comprises silicon dioxide, aluminum oxide, iron oxide, calcium oxide, and magnesium oxide. Fly ash obtained from burning bituminous coal contains less calcium oxide and iron oxide than fly ash obtained from burning sub-bituminous coal.

### Silica Fume

Silica fume is a by-product from the production of elemental silicon or alloys containing silicon in electric arc furnaces. Silica fume particles are small in size, having a mean primary particle size in the range of from 0.1 to 0.3 μm, and 95% of the particles being finer than 1 μm. The particles are spherical in shape. Silica fume is composed of about 85 wt %-95 wt % amorphous silicon dioxide (SiO₂).

### Metakaolin

Metakaolin is the anhydrous calcined form of the clay mineral kaolinite, Al₂O₃·2SiO₂·2H₂O. Metakaolin is a silica-based product that, on reaction with CaO or Ca(OH)₂, produces CSH gel at ambient temperature. Metakaolin also contains alumina that reacts with CH to produce additional alumina-containing phases, including C₄AH₁₃, C₂ASH₈, and C₃AH₆. High-reactivity metakaolin (HRM) is a highly processed reactive aluminosilicate pozzolan, a finely-divided material that reacts with slaked lime at ordinary temperature and in the presence of moisture to form a strong slow-hardening cement. It is formed by calcining purified kaolinite, generally between 650 and 700° C. in an externally fired rotary kiln.

Generally, the particle size of metakaolin is smaller than cement particles, but not as fine as silica fume. Metakaolin is 99.9% finer than 16 μm and has a mean particle size of 3 μm (as measured by MicroTrac laser diffraction granulometer method).

### Alumina

In some embodiments, alumina is included in the geopolymer compositions as an additional source of aluminum oxide. One suitable source of alumina is Fused White Aluminum Oxide. Fused White Aluminum Oxide is a type of aluminum oxide ceramic product. Fused white aluminum oxide is a high strength, wear-resistant material possessing a strong ability to resist vigorous chemical attacks (such as acid and alkali) at extreme temperatures. Its high degree of refractoriness, along with its superior electrical insulating properties, dielectric properties, and high melting point make White Fused Aluminum Oxide a desirable material choice for a diverse range of applications. Typical composition includes AlO₃=99.5%, TiO₂=0.0995%, SiO₂=0.05%, Fe₂=0.08%, MgO=0.02%, Alkali (Soda and Potash)=0.30%, specific gravity=3.95 g/cc, bulk density 116 lbs/ft³, and melting point is 2000° C. The particle size can vary from 2 μm to 254 μm. The amount of alumina can be in the range of 0% to about 10 wt %, based on the total weight of the composition.

### Volcanic Ash

Volcanic ash consists of fragments of rock, mineral crystals, and volcanic glass, produced during volcanic eruptions and measuring less than 2 mm in diameter. The volcanic rocks are ground to finer particle size and used as a partial substitute for Portland cement. The finer the size of volcanic ash particles, the better the reactivity with Portland cements. See, e.g., Kupwade-Patil, K, et al. “Water dynamics in cement paste at early age prepared with pozzolanic volcanic ash and Ordinary Portland Cement using quasi-elastic neutron scattering.” Cement and Concrete Research 86 (2016): 55-62; Kupwade-Patil, K, et al. “Particle size effect of volcanic ash towards developing engineered Portland cements.” Journal of Materials in Civil Engineering 30.8 (2018): 04018190. The primary constituents of volcanic ash are CaO=(8-12 wt %, Al₂O₃=12-20 wt %, SiO₂=35-55 wt %, MgO=3-8 wt %, Fe₂O₃=10-13 wt %), and provide a good source of alumino silicates.

### Aggregate

In addition to the alumino-silicate binder, the geopolymer compositions of the present technology comprise aggregate. Aggregate can include sands, such as silica sand, alumina sand, concrete sand (comprising limestone, gneiss, and granite), river sand (comprising silt), coral sand, glass sand, gypsum sand, biogenic sand (made from sea shells, corals, etc.), Olivine sand (comprising the mineral olivine which comprises magnesium iron silicate), volcanic sand, refractory sand, foundry sand, and quartz sand. Other aggregate sources can include crushed stone, gravel, or recycled concrete. The amount of aggregate in the geopolymer compositions can be in the range of about 20 wt % to about 65 wt %, based on the total weight of the composition. The aggregate can have a minimum particle size of about 37 μm, and a nominal maximum particle size of about 300 μm. In some embodiments, the particle size distribution of sand includes 2.35% of 297 μm, 27.92% of 149 μm, 34.60% of 74 μm and 35.13% of 50 μm. In some embodiments, the aggregate comprises silica sand having particle sizes in the range of about 10 μm to about 297 μm.

### Retarding Agent

In some embodiments of the present technology, particularly the embodiments in which slag is the only binder component, the geopolymer composition includes a retarding agent, or set retarder. The retarding agent comprises one or more components that function to delay the setting time of the geopolymer composition once the alkali activators are incorporated into the composition. The retarder also helps to make the geopolymer mixture workable. Suitable retarding agents include ZnO, zinc sulfate, phosphoric acid, sucrose, borax, HIDS (C₈H₇NO₉·4Na), and EDTA-4Na (C₁₀H₁₂N₂Na₄—O₈·4H₂O), calcium lignosulphonate, sodium tetraborate, tartaric acid, alkali metal halides, sodium chloride, malic acid. The amount of retarding agent added to the composition depends on a number of factors, including the amount of slag binder in the formulation, and whether the formulation is intended to be used as a trowel-applied formulation or a sprayable formulation. Typically, higher amounts of retarding agent are used in sprayable formulations compared to trowel-applied formulations to provide sufficient open time for the spraying. The amount of the retarding agent can also vary depending on the environmental temperature and humidity conditions during application of the geopolymer coating. The amount of the retarding agent can range from greater than 0%, such as about 0.3 wt %, up to about 10 wt % based on the total weight of the composition.

### Superplasticizer

The term “superplasticizer,” as used herein, is, generally, a water reducer, in particular, a high-range water reducer, or an additive that reduces the amount of water needed in a cementitious mix while still maintaining the workability, fluidity, and/or plasticity of the cementitious mix. Superplasticizers may include, but are not limited to formaldehyde condensates of at least one compound selected from the group consisting of methylolation and sulfonation products of each of naphthalene, melamine, phenol, urea, and aniline, examples of which include metal naphthalenesulfonate-formaldehyde condensates, metal melaminesulfonate-formaldehyde condensates, phenolsulfonic acid-formaldehyde condensates, and phenol-sulfanilic acid-formaldehyde co-condensates. Superplasticizers may also include the polymers and copolymers obtained by polymerizing at least one monomer selected from the group consisting of unsaturated monocarboxylic acids and derivatives thereof, and unsaturated dicarboxylic acids and derivatives thereof. Additional superplasticizers include polycarboxylate ethers and α-methallyl poly(ethylene glycol) ether (HPEG). In some embodiments, the superplasticizer comprises a polycarboxylate ether. The amount of superplasticizer can range from greater than 0% up to about 5 wt %, based on the total weight of the composition.

### Alkali Silicate

Compositions described herein require activation via an alkaline source to produce cementitious materials. Usually, alkaline salts are utilized as alkaline activators. In some embodiments, sodium hydroxide and/or sodium silicate are used due to their prevalence and ease of production.

Sodium silicate is a generic name for chemical compounds with the formula Na₂ₓSi_{y}O_{2y+x} or (Na₂O)ₓ·(SiO₂)_{y}, such as sodium metasilicate Na₂SiO₃, sodium orthosilicate Na₄SiO₄, and sodium pyrosilicate Na₆Si₂O₇. These compounds are generally colorless transparent solids or white powders, and soluble in water in various amounts.

Na₂SiO₃ is generally produced from silica and carbonate salts by calcination and dissolving in water according to the required ratios. Commercial types of liquid Na₂SiO₃ can be prepared by the mass ratio of SiO₂ to Na₂O from 1.2 to 3.75. The characteristics and structure of liquid Na₂SiO₃ can vary according to its composition, with sodium silicate being both anhydrous and hydrous.

The alkali silicate used as an activator in the geopolymer compositions of the present technology can be in liquid form, in powdered form, or a combination of liquid form and powdered form. The pH of the alkali silicate can range from about 10.5 to about 12.5. The amount of alkali silicate in the geopolymer composition can be in the range of about 10 wt % to about 35 wt %, based on the total weight of the composition. The amount of the alkali silicate also depends at least in part on the particular binder used in the composition, and whether the composition is intended as a trowel applied coating or a sprayable coating. For example, in some embodiments of the present technology that employ slag as the only binder component, the alkali silicate can be in a liquid form and comprise from about 35 wt % to about 40 wt % of the weight of the slag binder for trowel applied compositions, or from 85 wt % to 95 wt % of the weight of the slag binder for sprayable compositions. In some embodiments of the present technology that employ slag, fly ash, and alumina as the binder, both liquid and powder forms of the alkali silicate can be used, with the concentration of liquid alkali silicate ranging from 40 wt % to 45 wt % of the weight of the binder, and the concentration of sodium silicate powder ranging from 2 wt % to 6 wt % of the weight of the binder.

### Alkali Hydroxide

Alkali hydroxides may be used as activators in embodiments herein. Alkali hydroxides include NaOH, KOH, or LiOH. In some embodiments, the alkali hydroxide comprises NaOH. NaOH may be used as a solid in any form or as a liquid. The liquid sodium hydroxide should have a molarity in the range of 8 M to 18 M. The amount of the alkali hydroxide in the geopolymer composition can be in the range of about 3 wt % to about 15 wt %, based on the total weight of the composition. The amount of the alkali hydroxide also depends at least in part on the particular binder used in the composition, and whether the composition is intended as a trowel applied coating or a sprayable coating. For example, in some embodiments of the present technology that employ slag as the only binder, the alkali hydroxide can be in a concentration of about 20 wt % to about 25 wt % of the weight of the binder for trowel applied compositions, or 18 wt % to about 30 wt % of the weight of the binder for sprayable compositions.

### Microfiber Material

Mini- and/or microfibers can be included in the compositions described herein to help in mitigating drying shrinkage and cracking in the geopolymer coating. The fibers can be formed from different materials including, but not limited to, polypropylene, polyethylene, polyethylene terephthalate (PET), steel, glass fibers, nylon, lyocell, aramids, acrylic, and viscose rayon. In some embodiments, the microfibers are prepared from polypropylene or polyethylene. The size of the fibers can vary, but should be small relative to the thickness of the coating being formed from the composition. In general, fiber sizes are in the range of about 20 μm to about 2 mm. In some embodiments, the size of the fibers is about 28 μm. When used, the amount of the mini- and/or microfibers can be about 0.1-2.0 wt % of the weight of the binder.

### Shrinkage Reducing Admixture

The geopolymer compositions of the present technology also include a shrinkage reducing admixture to help minimize shrinkage of the coating after setting. The shrinkage reducing admixture can include, but is not limited to, one or more of monoalcohols, glycols having two hydroxyl functional groups bonded to two adjacent carbon atoms, polyoxyalkylene glycol alkyl ethers, polymeric surfactants, and amino alcohols. In some embodiments, the shrinkage reducing admixture comprises a polypropylene glycol-based shrinkage reducing admixture. The amount of the shrinkage reducing admixture in the composition can range from greater than 0 to about 5 wt %, based on the total weight of the composition.

### Method of Making Geopolymers

The present technology also encompasses methods of making the geopolymer compositions and coatings. The geopolymer compositions can be prepared by mixing together the dry components, namely the alumino-silicate source, aggregate, and admixture components (superplasticizer, shrinkage reducing admixture, and retarding agent and fibers, if used). Standard mixing equipment known to one skilled in the art may be used for mixing the dry components. In some embodiments, the dry components include slag, silica sand, superplasticizer, retarder, fibers and shrinkage reducing admixtures. In other embodiments, the dry components include slag, fly ash or other source of alumino-silicate, aluminum oxide powder, silica sand, superplasticizer, and shrinkage reducing admixture. After thorough mixing, the alkali silicate activator is added and thoroughly mixed into the dry component mixture, followed by mixing in the alkali hydroxide activator. In some embodiments, the alkali silicate activator comprises sodium silicate in liquid form, or a combination of liquid and powdered sodium silicate, and the alkali hydroxide activator comprises sodium hydroxide in liquid form. Thorough mixing of the sodium silicate with the dry components can generally be accomplished in about 1-2 minutes, after which sodium hydroxide in liquid form is added to the mixture and mixed for 3 minutes. The order of addition of the alkali silicate activator and the alkali hydroxide activator may be important for obtaining the (C, N)-A-S-H/C-A-S-H gel structures.

After mixing the alkali activators, the geopolymer coating composition is applied to a substrate, and allowed to cure. The geopolymer coating composition can be applied to a substrate using a trowel, or it could be spray-applied or shotcrete-applied to the substrate, depending on the particular coating formulation. Substrate materials include but are not limited to concrete. In some embodiments, the substrate material can be old concrete pipes or old sewer liners prepared from calcium aluminate cement.

One advantage of the slag-based coatings of the present technology is that they can be cured entirely at ambient temperatures without heating, and still predominantly form (C,N)-A-S-H)/C-A-S-H gel systems. Ambient temperature curing advantageously eliminates the need for an external heating source to form (C,N)-A-S-H)/C-A-S-H gel systems. Geopolymer coatings that include fly ash in combination with slag may be cured at ambient temperature for a day, followed by curing at a temperature of about 40° C. for 3 days. Curing at 40° C. helps in predominantly forming (C,N)-A-S-H gel structures and minor forms of Calcium-Aluminum-Silicate-Hydrate (C-A-S-H) gels in geopolymer coatings comprising slag and fly ash. The final cured geopolymer coating can have a thickness ranging from about 1.5 mm to about 2.43 mm.

### Resulting Geopolymer and Uses

The slag-based geopolymers of the present technology predominantly form (C, N)-A-S-H gels due to high amounts, such as 20 wt % to 50 wt %, of calcium oxide present in the slag. (C, N)-A-S-H gels can be detected in the interfacial zone between the silica sand and silicate activated slag-based binders, and the reaction between silica sand, slag and activators (sodium silicate and sodium hydroxide) may also promote additional (C, N)-A-S-H gels. Without being bound by theory, it is believed that the (C,N)-A-S-H gels provide greater acid resistance, brine resistance, and elevated temperature resistance than geopolymers primarily composed of N-A-S-H- and/or C-A-S-H-systems. Geopolymers based on fly ash binders typically form N-A-S-H networks rather than (C, N)-A-S-H gels because fly ash binder systems typically have a low CaO content, such as less than 10 wt %. Using high calcium fly ash as the binder actually results in less durable coatings than low calcium content fly ash binders.

The combination of fly ash and slag in the binder provides geopolymers having a higher Ca content than fly ash binder systems, but less Ca content than slag-only binders. As the CaO content from slag increases in the geopolymer system, more (C, N)-A-S-H gel systems are formed, helping to provide better acid resistance, brine resistance, and elevated temperature resistance as compared to geopolymers based on fly ash only binder systems. The formation of extra calcium products in Ca-rich and Al-sufficient slag-based systems is likely helpful to retard the attack of sulfuric acid on the C-(N)-A-S-H gels.

The coatings formed from the geopolymer compositions of the present technology can withstand elevated temperatures without causing shrinkage cracking as well as resist sulfuric acid at a pH of 0.622. Additionally, the coatings are able to withstand brine exposure (sodium chloride and potassium chloride) at 250° F. (121° C.). Exposing the geopolymer coating to 250° F. (121° C.) in brine solution actually helps to self-heal and re-activate the unreacted fly ash or slag particles thus forming an additional protective barrier.

The combination of acid resistance, brine resistance, and elevated temperature resistance properties of the described geopolymer coatings provide significant advantages and improvements over current coatings known in the art. Acid attack on cementitious materials in sewage systems is a critical issue among aging civil infrastructure. Increasing urbanization, aging infrastructure, and population growth will increase the demand for more usage of sewage and wastewater tanks. Sewage networks represent an extremely aggressive environment, and the primary cause of degradation for concrete corrosion is due to in-situ production of sulfuric acid by bacteria. Current coatings for wastewater applications are not able to withstand the aggressive environment and need frequent repairs (mostly every 5-15 years) thus leading to huge costs for the repair and restoration of wastewater infrastructure systems. Most coatings fail between pH 1-3. However, as demonstrated in the Examples below, slag-based geopolymer coatings of the present technology can withstand a pH of 0.622, thus making them durable and useful as coatings for wastewater applications, among other applications. Advantageously, the slag-based coatings of the present technology can increase the service life of sewage systems by avoiding frequent repair/restoration services.

One skilled in the art will recognize that modifications may be made in the present technology without deviating from the spirit or scope of the invention. The invention is further illustrated by the following examples, which are not to be construed as limiting the invention in spirit or scope to the specific procedures or compositions described therein.

### EXAMPLES

### Example 1: Geopolymer Coating-Slag Binder

A geopolymer coating containing slag as the binder was prepared from the formulation shown in Table 2:

TABLE 2
Slag-Based Mix Design (mix 20)

| Component | Total (%) |
|---|---|
| Slag (Binder) | 38.68 |
| Silica Sand | 33.25 |
| Shrinkage Reducing Admixture (SRA) | 1.24 |
| Superplasticizer | 1.73 |
| Sodium Silicate (Liquid form) | 15.45 |
| Sodium Hydroxide (18.9M) | 9.27 |
| ZnO (Retarder) | 0.39 |
| Total | 100.00 |

To prepare the coating, the slag, silica sand, shrinkage reducing admixture, superplasticizers, and retarder were combined and thoroughly mixed together using standard mixing equipment known to one skilled in the art. The sodium silicate was then added to the mixture and mixed for at least 1-2 minutes, followed by the addition of sodium hydroxide to the mixture. The entire mixture was then mixed for at least 3 minutes. The mixture was troweled onto a substrate and allowed to cure at ambient temperature.

### Example 2: Geopolymer Coating-Fly Ash/Slag/Aluminum Oxide Binder

A geopolymer coating containing fly ash, slag, and aluminum oxide powder as the binder was prepared from the formulation shown in Table 3:

TABLE 3
Mix design (18) that consists of Fly
ash, Slag and Aluminum Oxide Powder

| | Total | Binders |
|---|---|---|
| Component | (%) | (%) |
| Fly Ash | 20.34 | 66.44 |
| Slag | 8.29 | 27.06 |
| Aluminum Oxide Powder | 1.99 | 6.50 |
| Silica Sand | 34.34 | Total = 100 |
| Shrinkage Reducing Admixture (SRA) | 0.73 | |
| Superplasticizer | 1.74 | |
| Sodium Silicate in Liquid Form | 13.02 | |
| Sodium Silicate (Powder) | 2.44 | |
| Sodium Hydroxide (18.9M) | 17.10 | |
| Total | 100.00 | |

To prepare the coating, the fly ash, slag, aluminum oxide powder, silica sand, shrinkage reducing admixture, and superplasticizer were combined and thoroughly mixed together using standard mixing equipment known to one skilled in the art. The sodium silicate in liquid form and sodium silicate in powder form were then added to the mixture and mixed for at least 1-2 minutes, followed by the addition of sodium hydroxide to the mixture. The entire mixture was then mixed for at least 3 minutes. The mixture was troweled onto a substrate and allowed to cure at 40° C.

### Example 3: Geopolymer Coating-Fly Ash Binder (Comparative)

A geopolymer coating containing fly ash as the binder was prepared from the formulation shown in Table 4:

TABLE 4
Fly Ash-Based Mix Design (Mix 3)

| Component | Total (%) |
|---|---|
| Fly Ash | 37.02 |
| Silica Sand | 31.82 |
| SRA | 0.59 |
| Superplasticizer | 1.01 |
| Sodium silicate (Liquid form) | 14.78 |
| Sodium Hydroxide (14M) | 14.78 |
| Total | 100 |

To prepare the coating, the fly ash, silica sand, shrinkage reducing admixture, and superplasticizer were combined and thoroughly mixed together using standard mixing equipment known to one skilled in the art. The sodium silicate was then added to the mixture and mixed for at least 1-2 minutes, followed by the addition of sodium hydroxide to the mixture. The entire mixture was then mixed for at least 3 minutes. The mixture was troweled onto a substrate and allowed to cure at 40° C.

### Example 4: Setting Time

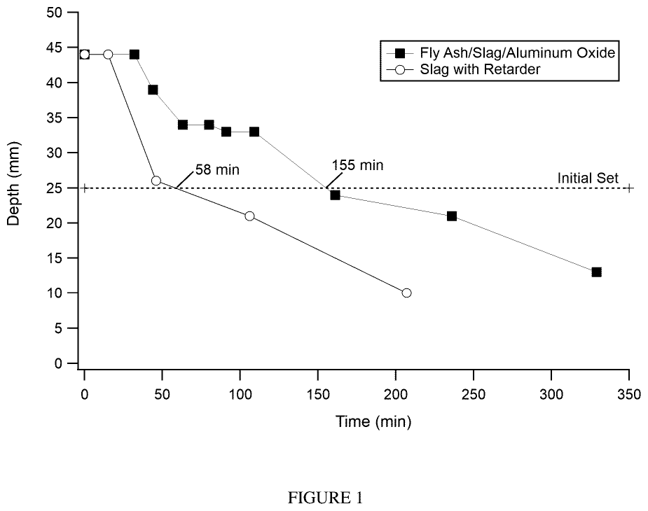

Setting time of the geopolymers prepared in Examples 1 and 2 was determined according to ASTM C191, Standard Test Methods for Time of Setting of Hydraulic Cement by Vicat Needle, ASTM Int'l. The setting time is shown in FIG. 1. The slag based geopolymer of Example 1 has an initial setting time of 58 minutes, while the fly ash/slag/aluminum oxide based geopolymer of Example 2 had a setting time of 155 minutes. Even though ZnO is used as a retarder in the slag based geopolymer of Example 1, the Example 1 geopolymer has a shorter setting time as compared to the fly ash/slag/aluminum oxide geopolymer of Example 2. The Example 1 geopolymer can be used for trowel-applied applications, but the setting time needs to be longer for a sprayable geopolymer composition.

### Example 5: Sprayable Geopolymers

Geopolymer coatings were prepared from formulations containing different amounts of ZnO as a retarding agent for retarding the setting time of the geopolymer coating. The amounts of ZnO in the formulations were about 1 wt % (Mix 23), about 2 wt % (Mix 28), about 3 wt % (Mix 24), and about 5 wt % (Mix 25) of the weight of the slag binder in the formulation. The formulations are shown in Tables 5, 6, 7, and 8, respectively:

TABLE 5
Slag-Based Mix Design 1 wt % ZnO (Mix 23):

| Component | % (Total) |
|---|---|
| Slag (Binder) | 30.71 |
| Silica Sand | 26.40 |
| Shrinkage Reducing Admixture (SRA) | 0.98 |
| Superplasticizer | 1.37 |
| Sodium Silicate (Liquid form) | 22.86 |
| Sodium Hydroxide (18.9M) | 17.32 |
| ZnO (Retarder) | 0.31 |
| Mini Fiber (Polyethylene) | 0.05 |
| Total | 100.00 |

TABLE 6
Slag-Based Mix Design 2 wt % ZnO (Mix 28)

| Component | % (Total) |
|---|---|
| Slag (Binder) | 30.56 |
| Silica Sand | 36.66 |
| Shrinkage Reducing Admixture (SRA) | 0.98 |
| Superplasticizer | 1.37 |
| Sodium Silicate (Liquid form) | 17.47 |
| Sodium Hydroxide (18.9M) | 12.20 |
| ZnO (Retarder) | 0.62 |
| Mini Fibers (Polyethylene) | 0.15 |
| Total | 100.00 |

TABLE 7
Slag-Based Sprayable Mix Design 3 wt % ZnO (Mix 24)

| Component | Total (%) |
|---|---|
| Slag (Binder) | 32.14 |
| Silica Sand | 27.62 |
| SRA | 1.03 |
| Superplasticizer | 1.44 |
| Liquid (Sodium Silicate) | 28.95 |
| Sodium Hydroxide (18.9M) | 7.70 |
| ZnO (Retarder) | 1.02 |
| Mini Fiber (Polyethylene) | 0.10 |
| Total | 100 |

TABLE 8
Slag-Based Sprayable Mix Design 5 wt % ZnO (Mix 25)

| Component | % (Total) |
|---|---|
| Slag (Binder) | 31.89 |
| Silica Sand | 27.51 |
| Shrinkage Reducing Admixture (SRA) | 1.02 |
| Superplasticizer | 1.43 |
| Sodium Silicate (Liquid form) | 28.73 |
| Sodium Hydroxide (18.9M) | 7.64 |
| ZnO (Retarder) | 1.63 |
| Mini Fiber (Polyethylene) | 0.15 |
| Total | 100.00 |

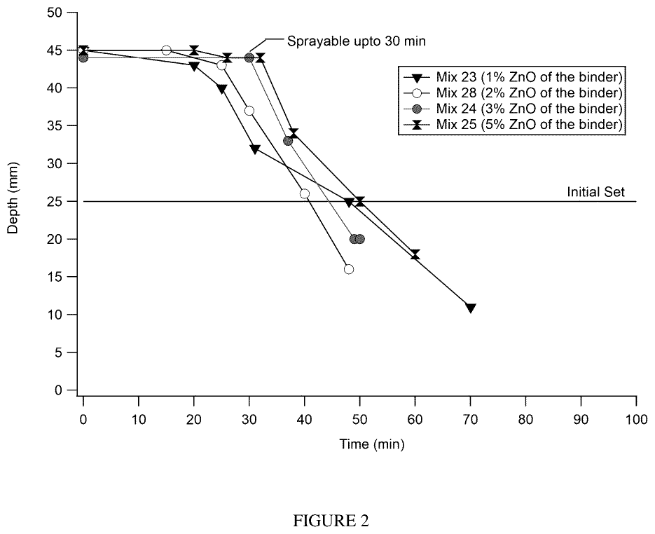

Each of the formulations also included polyethylene fibers. The setting time was determined according to ASTM C 191, and the results are graphically shown in FIG. 2. The graph in FIG. 2 shows that the formulations containing 3 wt % and 5 wt % of ZnO assisted in retarding setting of the mixture up to 30 minutes, and a drop in the depth of penetration from 45 mm to 25 mm was detected around 50 minutes for both formulations. The formulations containing amounts of 1 wt % and 2 wt % of ZnO were not as good as the formulations containing 3 wt % and 5 wt % of ZnO in retarding the setting time. The 30 minute retardation of the geopolymer matrix makes the coating sprayable. Without being bound by theory, adding 3 wt % and 5 wt % ZnO delayed the geopolymer reaction of slag by depleting the calcium ions in the pore solution that are required for the nucleation and growth of the C-N-A-S-H gel in the system. ZnO in an amount of at least 3 wt % of the weight of the slag binder is sufficient to make the geopolymer coating sprayable.

### Example 6: Bond Testing

Bond testing was performed on different geopolymer coatings according to ASTM D 7234 “Standard test method for pull-off adhesion strength of coatings on concrete using portable pull-off adhesion testers”. The geopolymer coatings tested were the coatings prepared from the formulations in Tables 2 (Mix 20), 4 (Mix 3), and 7 (Mix 24), a fly ash/slag/aluminum oxide based coating prepared from the formulation in Table 9 (Mix 17), and a slag-based geopolymer coating prepared from the formulation in Table 10 (Mix 22):

TABLE 9
Mix Design (17) Fly ash, Slag and Aluminum Oxide Powder

| Component | Total (%) |
|---|---|
| Fly Ash | 21.48 |
| Slag | 8.75 |
| Aluminum Oxide Powder | 2.10 |
| Silica Sand | 36.26 |
| Shrinkage Reducing Admixture (SRA) | 0.77 |
| Superplasticizer | 0.92 |
| Sodium Silicate in Liquid Form | 13.75 |
| Sodium Silicate (Powder) | 2.58 |
| Sodium Hydroxide (18.9M) | 13.39 |
| Total | 100.00 |

TABLE 10
Slag-Based Mix Design (Mix 22)

| Component | Total (%) |
|---|---|
| Slag (Binder) | 36.37 |
| Silica Sand | 31.26 |
| SRA | 1.16 |
| Superplasticizer | 1.63 |
| Sodium Silicate in liquid form | 14.52 |
| Sodium Hydroxide (18.9M) | 14.52 |
| ZnO (Retarder) | 0.36 |
| Green Dye | 0.18 |
| Total | 100.00 |

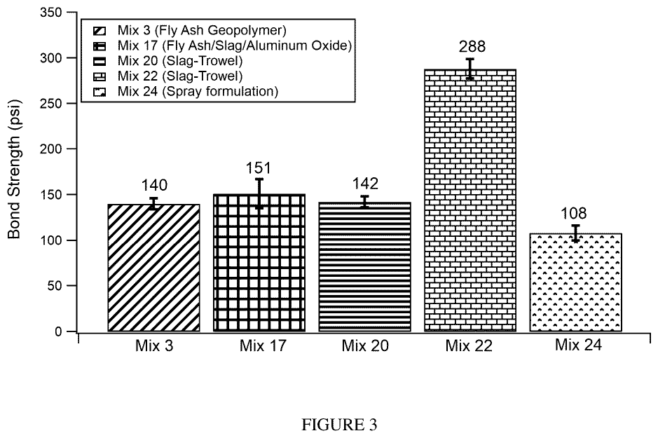

The substrate surface was mechanically hatched and cleaned from dust to ensure an adequate bond between the screed and substrate. The bond strength (psi) was measured as the ratio of the recorded force to the contact area between the screed composites and substrate. To obtain an average value of psi, three readings per mix were taken. The results of the bond testing are graphically shown in FIG. 3. The results show that the trowel applied slag-based coating of Table 2 (Mix 20) had an adhesion strength of 142 psi, which is comparable to the adhesion strength of 140 psi for the fly ash-based coating (Table 4 Mix 3) and the adhesion strength of 151 psi for the fly ash/slag/aluminum oxide coating (Table 9 M ix 17). The trowel applied slag-based coating of Table 10 (Mix 22) achieved an adhesion strength of 288 psi. The spray applied slag-based coating (Table 7 Mix 24) had an adhesion strength of 108 psi.

Changing the weight ratio of sodium hydroxide to sodium silicate in the slag-based compositions may affect the adhesion strength of the coating. The Table 7 spray applied formulation (Mix 24) has a sodium hydroxide to sodium silicate weight ratio of about 0.26, while the Table 2 trowel applied formulation (Mix 20) has a weight ratio of 0.6, and the Table 10 trowel applied formulation (Mix 22) has a weight ratio of 1.0. Increasing the sodium hydroxide to sodium silicate weight ratio in the slag based formulations may have helped to increase the bond strength from 108 psi for the spray applied formulation to 288 psi for the Table 10 trowel applied formulation.

### Example 7: High Temperature and Sulfuric Acid Exposure

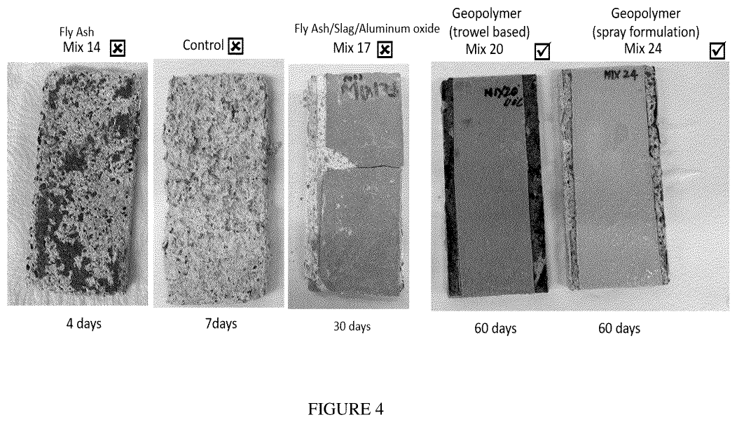

Samples of the Table 2 slag based geopolymer (Mix 20, ambient cured), the slag-based geopolymer spray formulation in Table 7 (Mix 24, ambient cured), the fly ash/slag/aluminum oxide geopolymer in Table 9 (Mix 17) (cured for 3 days at 40° C.), a fly ash geopolymer similar to Example 3 (Mix 14, cured for 3 days at 40° C.), and a concrete sample with no coating (control) were subjected to a temperature of 250° F. (121° C.). All the samples were able to withstand 250° F. (121° C.) with no shrinkage cracking. The samples were then subjected to sulfuric acid at pH of 0.622 for 60 days or until failure. The photographed results are shown in FIG. 4. The fly ash geopolymer sample showed severe signs of deterioration after 4 days of sulfuric acid exposure and was destroyed, the control concrete sample showed signs of deterioration after 7 days, and the fly ash/slag/aluminum oxide geopolymer showed signs of debonding after 30 days of sulfuric acid exposure. The slag based geopolymers showed no signs of deterioration even after 60 days of exposure. Without being bound by theory, it is believed that the higher concentrations of (C,N)-A-S-H gel polymer network in the slag based geopolymers compared to the fly ash geopolymer and fly ash/slag/aluminum oxide geopolymer provided enhanced resistance to sulfuric acid.

### Example 8: X-Ray Diffraction

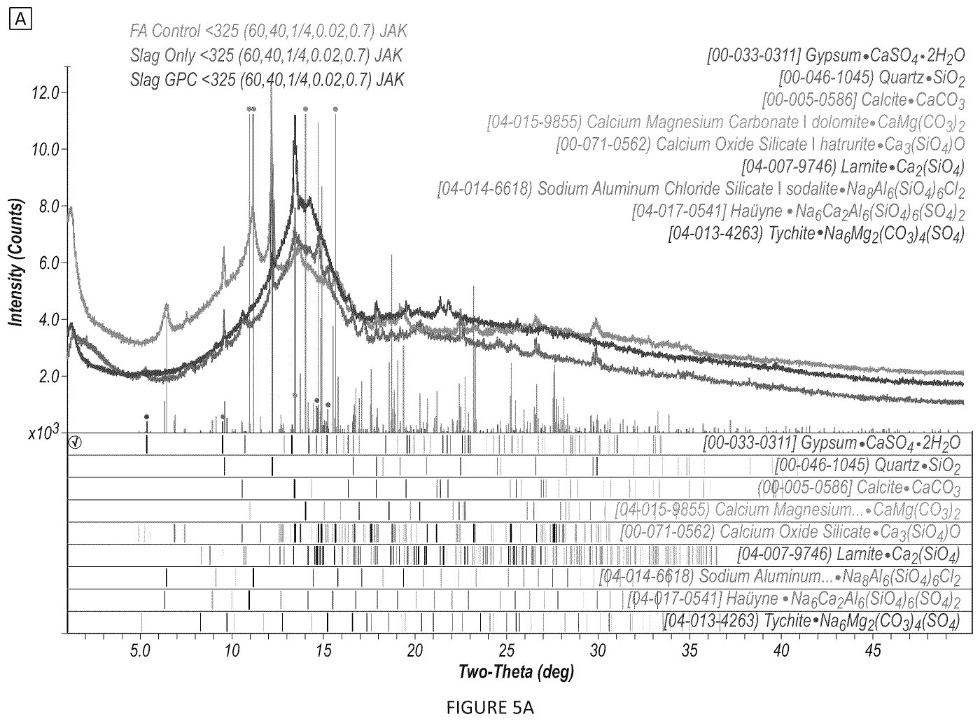

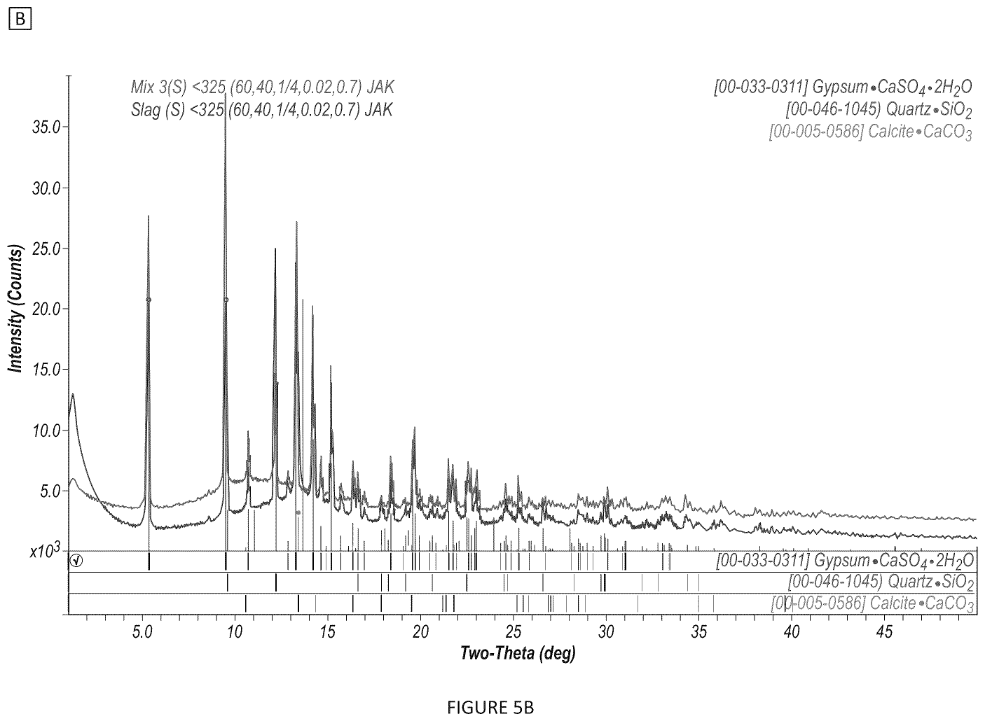

X-ray Diffraction was performed on geopolymer coatings namely slag based geopolymer (Example 1) and fly ash based geopolymer (Example 3). The results are shown in FIGS. 5A and 5B, and the phase % data is shown in Table 11. Slag by itself (“Slag Only” in FIG. 5A) was 97.8% amorphous and showed phases of quartz (0.2%), calcite (1.9%), and dolomite (Calcium magnesium carbonate) (˜0.2%). The amorphous content decreased from 97.8% to 94.5% when slag was alkali activated using sodium hydroxide and sodium silicate forming “slag based geopolymer” (“Slag GPC” in FIG. 5A). Other phases in the slag based geopolymer included 4% gypsum, 3.2% quartz, 0.5% calcite, 0.3% hatrurite (alite, C₃S) and 1% larnite (belite, C₂S). (C,N)-A-S-H gel can be related to the amorphous phase in the slag based geopolymer system. “FA Control” in FIG. 5A shows the x-ray diffraction data for the fly ash based geopolymer. When both slag based geopolymer (Example 1) and fly ash based geopolymer (Example 3) were exposed to 0.622 pH sulfuric acid for 30 days, the amorphous phase dropped 94.5% to 67.9% and 88.5% to 68.7%, respectively, as shown in FIG. 5B, indicating decalcification of the geopolymeric gel. Gypsum content significantly increased in both the fly ash and slag based geopolymer when the samples were exposed to sulfuric acid. In the fly ash based geopolymer, the main geopolymer gel was Sodium-Aluminum-Silicate-Hydrate (N-A-S-H), while (C,N)-A-S-H/C-A-S-H gel was the primary binding gel for the slag-based geopolymer. However, the photographic data shown in FIG. 4 clearly shows that the slag based geopolymers were able to survive the sulfuric acid exposure whereas the fly ash geopolymer was not able to withstand the harsh sulfuric exposure. This suggests that (C,N)-A-S-H gels are more durable than N-A-S-H gel as the additional calcium in the C-N-A-S-H helps to retard the sulfuric acid attack by preventing leaching of the silicon ions from the gel. (Wang, Y, et al. “Intrinsic sulfuric acid resistance of C-(N)-ASH and NASH gels produced by alkali-activation of synthetic calcium aluminosilicate precursors.” Cement and Concrete Research 165 (2023): 107068). The slag based geopolymer showed additional formation of calcite when exposed to sulfuric acid, while no traces of calcite were found in the fly ash based geopolymer. Studies show the calcite helps in developing denser microstructure as well as provides strength to the C-A-S-H gels. Therefore, formation of calcite may have also contributed to the durability of the slag based geopolymers. (Kupwade-Patil, K, et al. “Particle size effect of volcanic ash towards developing engineered Portland cements.” Journal of Materials in Civil Engineering 30.8 (2018): 04018190).

TABLE 11
Phase % performed via Rietveld refinement on the X -
ray Diffraction data as shown in FIGS. 5A and 5B

| | Sample Name | | | | |
|---|---|---|---|---|---|
| Phases (%) | Slag (S) | Mix 3 (S) | Slag Only | Slag GPC | FA control |
| Amorphous | 67.9 | 68.7 | 97.8 | 94.5 | 88.5 |
| Gypsum | 20.4 | 27.3 | | 0.4 | |
| Quartz | 6.1 | 4.0 | 0.2 | 3.2 | 3.2 |
| Calcite | 5.6 | | 1.9 | 0.5 | 0.3 |
| Dolomite | | | 0.2 | | |
| Hatrurite | | | | 0.3 | 1.1 |
| Larnite | | | | 1.0 | |
| Sodalite | | | | | 6.8 |
| Other | | | | trace | |

Slag (S): Example 1- Slag geopolymer exposed to sulfuric acid
Mix 3 (S): Example 3- Fly ash geopolymer exposed to sulfuric acid
Slag only: Base slag powder
Slag GPC: Example 1- Slag geopolymer
FA control: Example 3- Fly ash geopolymer

### Example 9: 27Al MAS NMR Testing

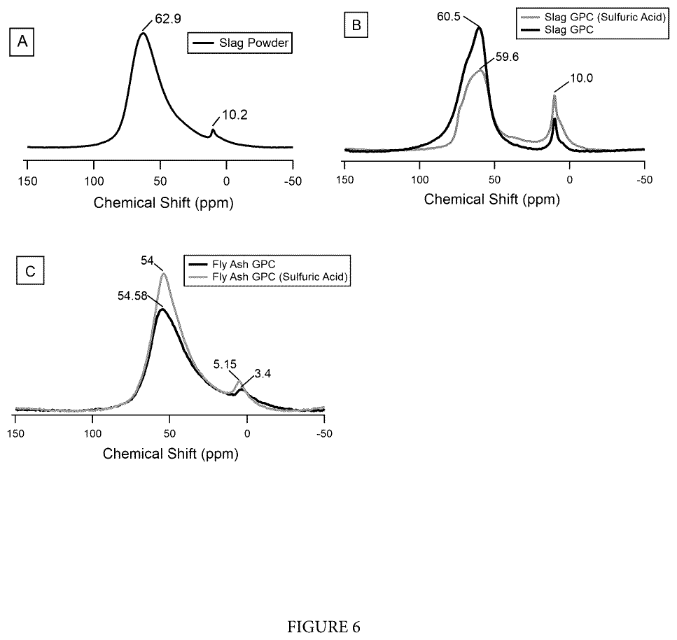

²⁷Al MAS NMR data was performed on samples of slag powder, Slag Geopolymer Coating (GPC) (Example 1) and Fly Ash GPC (Example 3) before and after exposure to sulfuric acid. The ²⁷Al MAS NMR data is shown in FIG. 6. The samples show signals of Al (IV), Al (V), and Al (VI) at 55-75 ppm, 35-40 ppm, and −10 to +20 ppm, respectively. Slag powder showed a broad resonance between 50-80 ppm, centered around 62.9 ppm assigned to Al (IV) in the glassy phase of the slag (A). Upon alkali activation for the slag GPC, the primary resonance lies between 58 and 61 ppm which is assigned to the [AlO₄]⁵⁻ tetrahedra that can be related to the bridge sites in the Si—O chains of the poorly crystalline (C,N)-A-S-H gels (B).

After exposure to sulfuric acid at pH of 0.622 for 30 days, both the fly ash and slag geopolymer coating samples moved towards lower resonances for Al (IV). The fly ash geopolymer sample exposed to sulfuric acid moved towards 54 ppm (C), while the slag GPC sample exposed to sulfuric acid shifted from 60.5 to 59.6 ppm (B). The movement closer to 50 ppm for the fly ash sample relates to the dealumination of C-(N)-A-S-H/N-A-S-H gels due to acid attack. The slag GPC sample exposed to sulfuric acid had a lower Al (IV) intensity; whereas the fly ash GPC had a higher intensity for Al (IV) after exposure to sulfuric acid that could be due to overlapping of the tetrahedral Al (IV) and Al (V). This suggests that the fly ash GPC had higher alumina due to the decomposition of alumina containing AFm phases and CₓAH_{y} phases. Fly ash GPC is predominantly dominated by N-A-S-H gel, and ²⁷Al NMR data suggest that the Al—O bonds in N-A-S-H gel are highly vulnerable to acid attack. On the contrary, the additional alumina phase in slag GPC protects against dealumination of C-(N)-A-S-H gel from acid corrosion. Subtle variations in the coordination of aluminum have a strong relationship with the initial calcium and aluminum content of the samples. High calcium/alumina content in slag-based GPC promotes formation of aluminate phases in the octahedral Al (VI) in addition to C-N-A-S-H gels, thus providing additional resistance against sulfuric acid exposure.

### Example 10: Brine Testing

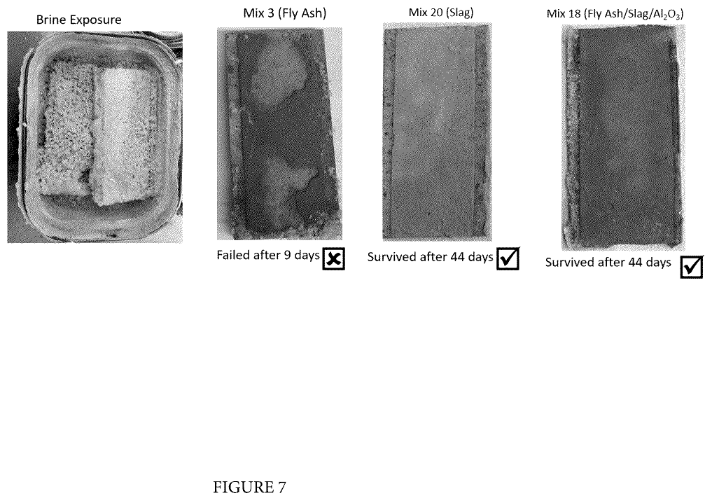

The Example 1 slag based geopolymer, the Example 2 fly ash/slag/aluminum oxide geopolymer, and the Example 3 fly ash geopolymer were tested for brine resistance. For the testing, each geopolymer sample was submerged in a brine solution of sodium chloride (5M) and potassium chloride (4M) with a pH of 5.68 and exposed to 250° F. (121° C.) for 44 days or until coating failure. The photographed results are shown in FIG. 7. Similar to the sulfuric acid testing in Example 7, the Example 3 fly ash based geopolymer could not survive the brine exposure and failed after 9 days. The fly ash based geopolymer did not have sufficient alumina to provide the enhanced geopolymeric network and therefore the binder was destroyed when exposed to the brine solution, as shown in FIG. 7. After 44 days of brine exposure at 250° F. (121° C.) the fly ash/slag/aluminum oxide geopolymer (Example 2) was able to survive the brine attack due to the additional alumina provided by inclusion of slag and Al₂O₃. The Example 1 slag based geopolymer was also able to survive the brine attack after 44 days of exposure, and no signs of delamination were observed on the slag based geopolymer. The Example 1 and Example 2 geopolymers formed (C, N)-A-S-H/C-A-S-H gels that provided additional densification of the matrix, enabling the geopolymers to withstand the brine environment at elevated temperature.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

1. A geopolymer coating composition comprising, in total weight percent:
(a) 20-50 wt % of an alumino-silicate source comprising at least 20 wt % slag, based on the total weight of the alumino-silicate source;
(b) 20-65 wt % aggregate;
(c) >0-5 wt % superplasticizer;
(d) 10-35 wt % of an alkali silicate component;
(e) 3-15 wt % of an alkali hydroxide component; and
(f) >0-10 wt % retarding admixture.

2. The composition of claim 1, wherein the slag comprises:
(a) 30-60 wt % SiO2;
(b) 5-25 wt % Al₂O₃;
(c) 0-8 wt % Fe₂O₃;
(d) 5-50 wt % CaO; and
(e) 0-15 wt % MgO.

3. The composition of claim 1, wherein the slag is ground granulated blast-furnace slag and has a characteristic particle size, De, from 2 μm to 50 μm and a loss on ignition of less than 3 wt %.

4. The composition of claim 1, wherein the aggregate comprises silica sand, alumina sand, refractory sand, foundry sand, crushed stone, gravel, or recycled concrete.

5. The composition of claim 1, wherein the aggregate has a nominal maximum particle size of about 300 μm and a minimum particle size of 37 μm.

6. The composition of claim 1, wherein the superplasticizer comprises one or more of sulfonated synthetic polymer, polycarboxylate ether, metal naphthalenesulfonate-formaldehyde condensate, metal melaminesulfonate-formaldehyde condensate, phenolsulfonic acid-formaldehyde condensate, phenol-sulfanilic acid-formaldehyde co-condensate, and α-methallyl poly(ethylene glycol) ether (HPEG).

7. The composition of claim 1, wherein the alkali silicate component is from 10-20 wt % or from 20-35 wt %.

8. The composition of claim 1, wherein the alkali silicate component comprises a liquid sodium silicate formulation comprising at least 15 wt % sodium silicate, wherein the liquid sodium silicate formulation has a pH of 8 or greater at standard temperature and pressure.

9. The composition of claim 1, wherein the alkali hydroxide component comprises an aqueous alkali hydroxide formulation comprising at least 3 wt % alkali hydroxide, wherein the aqueous alkali hydroxide formulation has a pH of 10 or greater at standard temperature and pressure.

10. The composition of claim 1, wherein the composition further comprises >0 to 5 wt % shrinkage reducing agent comprising one or more of monoalcohols, glycols having two hydroxyl functional groups bonded to two adjacent carbon atoms, polyoxyalkylene glycol alkyl ethers, polymeric surfactants, and amino alcohols.

11. The composition of claim 1, wherein the retarding admixture comprises one or more of ZnO, zinc sulfate, phosphoric acid, sucrose, borax, HIDS (C₈H₇NO₉·4Na), and EDTA-4Na (C₁₀H₁₂N₂Na₄—O₈·4H₂O), calcium lignosulphonate, sodium tetraborate, tartaric acid, alkali metal halides, sodium chloride, and malic acid.

12. A method of forming a geopolymer, the method comprising:
(a) forming a dry admixture of components comprising:
(i) an alumino-silicate source comprising at least 20 wt % slag, based on the total weight of the alumino-silicate source;
(ii) aggregate;
(iii) superplasticizer; and
(iv) retarding admixture, wherein the alumino-silicate source is in an amount of 20-50 wt %, the aggregate is in an amount of 20-65 wt %, the superplasticizer is in an amount of >0-5 wt %, and the retarding admixture is in an amount of >0-10 wt %, based on total weight of the geopolymer;
(b) mixing an alkali silicate component with the dry admixture to form a mixture, wherein the alkali silicate component is in an amount of 10-35 wt %, based on the total weight of the geopolymer;
(c) mixing an alkali hydroxide component with the mixture formed from step (b) to initiate an alkali activation process and form an activated composition; and
(d) curing the activated composition to form a geopolymer.

13. The method of claim 12, wherein the dry admixture of components and the alkali silicate component are mixed for at least one minute before the alkali hydroxide is added.

14. The method of claim 12, wherein curing is done at ambient temperature.

15. The method of claim 12, wherein curing is done for 24-72 hours at a temperature of 40° C. or greater.

16. The method of claim 12, wherein the geopolymer has a pull-off adhesion strength of 100 psi to 300 psi when measured using an M D 7234 test.

17. The method of claim 12, wherein the geopolymer does not degrade when the geopolymer is immersed in a solution of sulfuric acid having a pH of 0.7 at a temperature of 40° C. for 300 hours.

18. The method of claim 12, wherein the geopolymer does not degrade when the geopolymer is immersed in a solution of 5M NaCL and 4 M KCl with a pH of 5.68 at a temperature of 250° C. for 72 hours.

19. A geopolymer formed from the geopolymer composition of claim 1 wherein the geopolymer comprises a crystalline (C, N)-A-S-H phase at 29° 2θ using x-ray diffraction and ²⁷Al MAS NMR around 50-60 ppm.

20. A structure comprising a cementitious material and the geopolymer of claim 19.
